(19) United States
(12) Patent Application Publication
(10) Pub. No.: US 2022/0279929 A1
(43) Pub. Date: Sep. 8, 2022

(54) WELL-BEING HEATING CHAIR AND METHOD FOR MANUFACTURING SAME

(71) Applicant: Heungmuk LIM, Namyangju-si (KR)

(72) Inventor: Heungmuk LIM, Namyangju-si (KR)

(21) Appl. No.: 17/631,848

(22) PCT Filed: Jul. 30, 2020
(86) PCT No.: PCT/KR2020/010050

§ 371 Date: Jan. 31, 2022

(30) Foreign Application Priority Data
Jul. 30, 2019 (KR) 10-2019-0092341
Jul. 30, 2019 (KR) 10-2019-0158885
Dec. 4, 2019 (KR) 10-2019-0159878

(51) Int. Cl. A47C 7/74; A47C 5/00; C04B 14/20; C04B 18/10; C04B 24/34; C04B 24/02; C04B 28/26

(52) U.S. Cl. CPC A47C 7/748; A47C 5/00; C04B 14/20; C04B 18/10; C04B 24/34; C04B 24/02; C04B 28/26; C04B 2111/00465

(57) ABSTRACT

The present invention relates to a well-being heating chair and a method for manufacturing same. The well-being heating chair is not harmful to the body, for an environment-friendly composition is used, can provide a humidity control function, antimicrobial activity, deodorization and the like, is light weight relative to the volume and thus can be handled easily, is non-flammable and has excellent compressive strength.

### TECHNICAL FIELD

The present invention relates to a well-being heating chair and a method for manufacturing the same, and more particularly, a well-being heating chair that is environmentally friendly and harmless to the human body, has a humidity control function, antimicrobial activity and deodorization property so that, when a part of the chair is in repetitive contact with the human body, the chair can contribute on minimization of skin irritation at the part, improvement of quality of surrounding air, and creation of a pleasant environment, as well as a method for manufacturing the same.

### BACKGROUND ART

Chairs used when people sit may be made of various materials but, in recent years, the demand for bonded wood products such as plywood, particleboard, fiberboard, or the like, which are processed and bonded using veneer, sawdust, fiber, etc. is steadily increasing because these are cheaper than solid wood. Such wood-based board products contain formaldehyde-based adhesives that are harmful to the human body and are immersed in formalin for preservative treatment, and the finished wood as described above is commonly used to manufacture chairs.

However, such wood discharges a large amount of harmful substances such as toluene, xylene and ethylbenzene, and thus, may cause various diseases including skin diseases such as atopic dermatitis and rhinitis.

There is still a limitation in making wood to exist as a breathe material while supplementing the defects of wood in order to reduce discharge of harmful VOCs (Volatile Organic Compounds) for eco-friendly furniture, and while removing harmful substances emitted from the paint itself.

In order to solve the above disadvantages, a functional paint applied to the surface of a chair is recently used to paint the chair, but this functional paint has a disadvantage in that the function thereof is deteriorated by half when being dried after application.

Further, since the processed wood is very susceptible to fire and for the purpose of solving the problem related to incombustibility, the processed wood including various types of incombustible compositions is being manufactured.

However, conventional incombustible compositions typically use non-flammable agents or flame retardants made of diverse kinds of chemical substances to decrease the price. In this case, the chemical substances include formalin, toluene, volatile organic materials, etc. to thus not only cause different problems which are harmful to the human body such as various allergic diseases or respiratory diseases but also generate environmental pollution when discarded.

### PRIOR ART LITERATURE

### Patent Literature

(Patent Document 1) Korean Patent Publication No. 10-0695910

(Patent Document 2) Korean Patent Publication No. 10-1213988

### DISCLOSURE

### Technical Problem

The present invention has been devised to solve the problems of the prior art, and it is an object of the present invention to provide a well-being heating chair that is environmentally friendly and harmless to the human body, has a humidity control function, antimicrobial activity and deodorization property so that, when a part of the chair is in repetitive contact with the human body, the chair can contribute on minimization of skin irritation at the part, improvement of quality of surrounding air, and creation of a pleasant environment, as well as a method for manufacturing the same.

### Technical Solution

The chair according to the present invention is a means for achieving the above object, which includes: a compact body including a plate-shaped plate compact member and a rod-shaped support compact member; a heat transfer unit built in the plate compact member; and a charcoal block built in the plate compact member and disposed on one side of the heat transfer unit, wherein the plate compact member is used as a seat and a backrest of the chair, and the support compact member is used as a leg of the chair.

Further, the compact body may composed of: a second mixture prepared by admixing expanded vermiculite pulverized into 20 to 25 mesh after heating the same at 1,000 to 1,100° C. and 5 to 30 parts by weight (“wt. parts”) of a first mixture with respect to 100 wt. parts of the expanded vermiculite; and a third mixture prepared by admixing liquid sodium silicate and charcoal pulverized into 300 to 325 mesh, wherein: the first mixture includes 50 to 70% by weight (“wt. %”) of rosin powder pulverized into 300 to 325 mesh and to 50 wt. % of alcohol to a total weight; the second mixture is formed by simultaneously introducing the first mixture and the expanded vermiculite into a mixer and mixing the same, followed by agitating the mixture at 100° C. for 1 to 2 hours then naturally cooling the same, and repeating this process 5 times; the third mixture is formed by repeating a pressing process in a rolling mill 3 times; a fourth mixture is prepared by agitating 80 to 95 wt. % of the second mixture and 5 to 20 wt. % of the third mixture for 2 to 3 hours; the fourth mixture is pressed by means of a hydraulic press having a pressure of 2,000 to 2,300 tons at 180 to 230° C. for 5 minutes to form a compact body; and the first mixture is formed by admixing the rosin powder and alcohol at room temperature.

Further, the third mixture may include 40 to 80 wt. parts of charcoal based on 100 wt. parts of liquid sodium silicate, wherein the charcoal may include 10 to 25 wt. % of first charcoal powder based on an oak tree as a raw material and having a rod-shaped structure, 25 to 45 wt. % of second charcoal powder based on a pine tree as a raw material and having a spherical structure, and 20 to 45 wt. % of third charcoal powder formed by burning rice husk at a high temperature under vacuum condition.

Further, the method for manufacturing a well-being heating chair may include: (a) preparing a compact body; (b) mounting a heat transfer unit in a plate compact member; and (c) mounting a charcoal block in the plate compact member so that the charcoal block is disposed on one side of the heat transfer unit.

In this regard, the step (a) may include: a first process of preparing a first mixture by admixing 50 to 70 wt. % of rosin powder pulverized into 300 to 325 mesh and 30 to 50 wt. % of alcohol at room temperature; a second process of heating vermiculite at 1,000 to 1,100° C. to prepare expanded vermiculite, followed by pulverizing the same into to 25 meshes; a third process of preparing a second mixture in a liquid state by mixing 5 to 30 wt. parts of the first mixture with respect to 100 wt. parts of the expanded vermiculite, followed by agitating the same at 100 ° C.; a fourth process of preparing a third mixture in a liquid state by admixing liquid sodium silicate and 40 to 80 wt. parts of charcoal pulverized into 300 to 325 mesh with respect to 100 wt. parts of the liquid sodium silicate, followed by agitating the same for 2 to 3 hours; a fifth process of preparing a fourth mixture by agitating 80 to 95 wt. % of the second mixture and 5 to 20 wt. % of the third mixture for 2 to 3 hours with respect to a total weight of the fourth mixture; a sixth process of pressing the fourth mixture by means of a hydraulic press having a pressure of 2,000 to 2,300 tons at 180 to 230° C. for 5 minutes to form a compact body composed of a rod-shaped support compact member and a plate-shaped plate compact member; a seventh process of demolding and naturally cooling the compact body for 72 hours or more; an eighth process of removing foreign substances including impurities on the surface of the compact body; a ninth process of firstly coating a top surface and lateral sides of the compact body with an inorganic binder then drying the same, followed by turning the compact body over, secondly coating a bottom surface and lateral sides of the compact body with an inorganic binder then drying the same; and a tenth process of assembling the support compact member and the plate compact member to construct a chair like structure.

### Advantageous Effects

According to the present invention, eco-friendly compositions such as expanded vermiculite, charcoal and liquid sodium silicate are used, and various functional characteristics such as humidity control function, antimicrobial and deodorization properties can be provided by the expanded vermiculite and charcoal. Further, it is possible to prevent different allergic diseases or respiratory diseases occurring due to a chair that is in directly or indirectly contact with the human body.

Further, since the chair is molded while filling a a gap between the expanded vermiculite and the charcoal with the rosin powder in a state in which the charcoal is combined with the expanded vermiculite made of porous material, the manufactured chair is lightweight compared to the volume thereof, and non-flammable while having excellent compressive strength compared to the existing incombustible materials, thereby attaining effects of increasing the added value of the chair.

Further, if the chair manufactured according to the present embodiment is pulverized and liquefied when discarded, it may be used again as a material for other furniture materials, thereby having advantages in recycling of resources and environmental protection.

### DESCRIPTION OF DRAWINGS

FIG. 1 illustrates the overall appearance of a well-being heating chair according to the present invention.

FIG. 2 is a diagram showing an exploded configuration of a block of charcoal.

FIG. 3 illustrates a state in which charcoal blocks are applied to both the seat and the backrest.

FIG. 4 is a diagram showing a cross-sectional configuration of a plate compact member, specifically illustrating an example in which the heat transfer unit is composed of an electric heating wire.

FIG. 5 is a diagram showing a cross-sectional configuration of a plate compact member, specifically illustrating an example in which the heat transfer unit is composed of a planar heating element.

FIG. 6 is a flowchart illustrating a method of manufacturing a compact body according to an embodiment of the present invention.

FIG. 7 is a flowchart illustrating a method of manufacturing a compact body according to another embodiment.

FIGS. 8 to 10 are diagrams showing a schematic appearance of a well-being heating chair according to an embodiment of the present invention.

FIG. 11 is a photograph showing the expanded vermiculite used in an embodiment of the present invention.

FIG. 12 is a photograph showing the rosin powder used in an embodiment of the present invention.

FIG. 13 is a photograph showing a state of the third charcoal powder used in an embodiment of the present invention before pulverization.

### BEST MODE

Hereinafter, preferred embodiments of the present invention will be described. However, the scope of the present invention is not limited to the embodiments described below and is defined by what is described in the claims, and those having ordinary skill in the field (“those skilled in the art”) to which the present invention pertains can implement various modifications and alterations within the scope of the invention described in the claims.

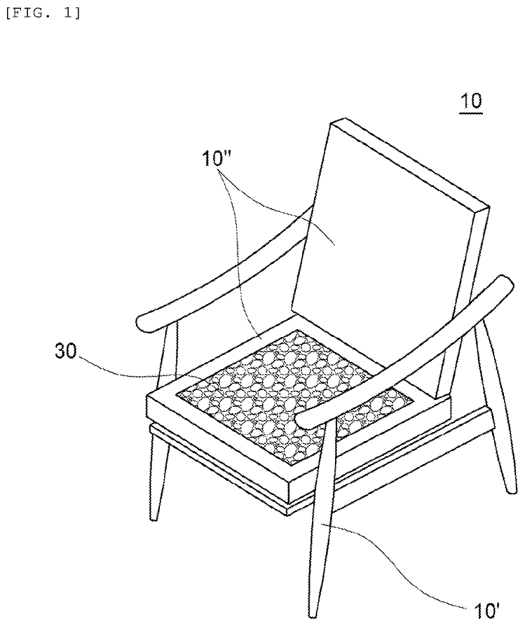

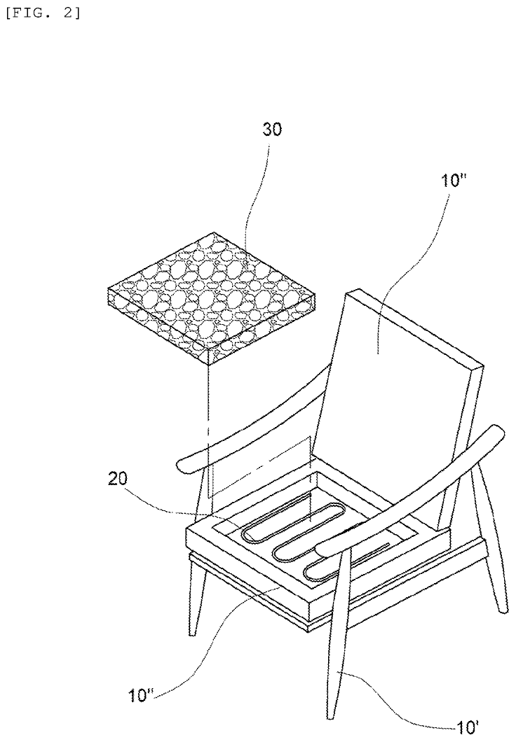

As shown in FIGS. 1 and 2, the chair 10 according to the present invention may include: a compact body composed of a plate-shaped plate compact member 10″ and a rod-shaped support compact member 10′; a heat transfer unit 20 built in the plate compact member 10″; and a charcoal block 30 built in the plate compact member 10″, wherein the charcoal block is disposed at one side of the heat transfer unit 20.

The plate compact member 10″ may be used as a seat and a backrest of the chair 10, while the support compact member 10′ may be used as a leg of the chair 10. A chair-shaped structure may be formed by properly combining the plate compact member 10″ and the support compact member 10′.

An insert groove into which the heat transfer unit 20 and the charcoal block 30 are inserted may be formed in the plate compact member 10″.

The charcoal block 30 may be prepared using raw materials made of oak and pine. The charcoal block 30 used herein may be formed by adding a binder to charcoal powder and then compressing the same, or by cutting a solid charcoal into a predetermined shape.

Charcoal is a natural material that is harmless to the human body and is eco-friendly, has excellent humidity control functions, as well as excellent antimicrobial, sterilization and deodorization properties, and may be expected to emit far-infrared rays.

The heat transfer unit 20 is a means with heating functions, may increase the body temperature of a seated person on a chair, and may promote sterilization, deodorization and far-infrared radiation efficiency of the charcoal block 30.

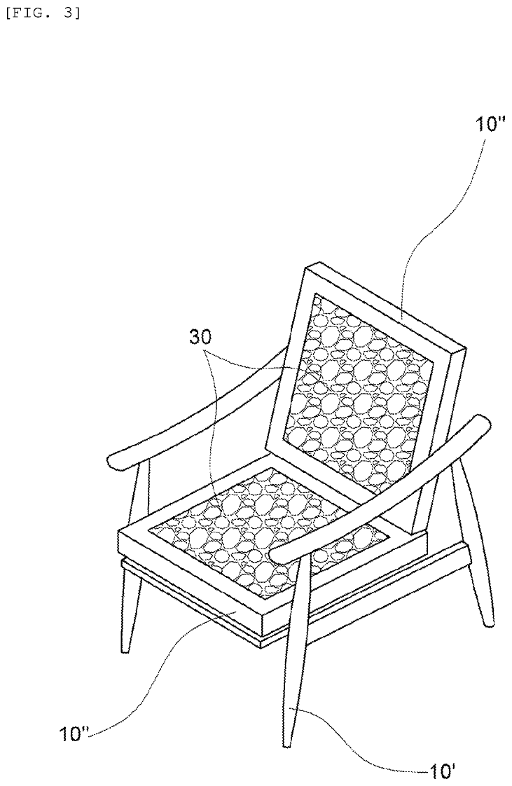

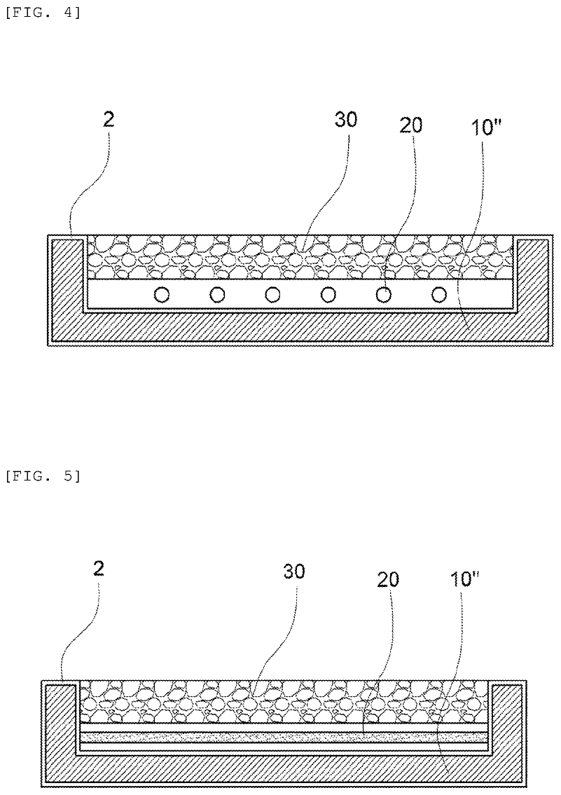

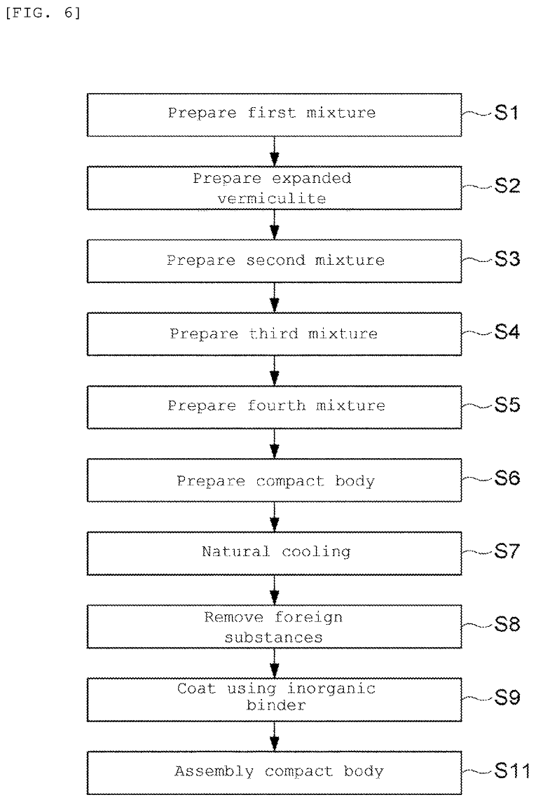

The heat transfer unit 20 used herein may be configured using an electric heating wire, a planar heating element, etc., which are known in the art, as shown in FIGS. 3 to 4.

The well-being heating chair according to an embodiment of the present invention may include a coating layer 2 to cover the surface of the compact body.

The coating layer 2 may be formed by coating the surface of the compact body with an inorganic binder.

Herein, the compact body may be formed by while including 90 wt. % of the second mixture and 10 wt. % of the third mixture based on a total weight thereof.

The second mixture may be formed by admixing expanded vermiculite and 5 to 30 wt. parts of the first mixture based on 100 wt. parts of the expanded vermiculite.

At this time, if a content of the first mixture is less than 5 wt. parts, a bonding force of the rosin powder is not sufficient so that the strength of a chair may be reduced. Further, a relatively high content of the expanded vermiculite may cause problems in that homogeneity of the second mixture is deteriorated, such as not being properly liquefied when the second mixture is prepared, or a part of the expanded vermiculite is locally agglomerated. The homogeneity problem may consequently act as a cause of reducing the compressive strength of the chair.

Further, when the content of the first mixture exceeds 30 wt. parts, the content of the expanded vermiculite is relatively small, and various effects of the expanded vermiculite may not be properly implemented.

At this time, the expanded vermiculite may be pulverized into particles having a size of 20 to 25 mesh. If the size of the pulverized expanded vermiculite is less than 20 mesh, there may be a problem that the vermiculite particles are exposed to the surface of the molded chair, hence making an ill appearance visually. When the size of the pulverized expanded vermiculite exceeds 25 mesh, it is not easy to admix raw materials and the liquefaction of the second mixture is not properly performed, thus causing problems in manufacturing.

Further, the expanded vermiculite is lightweight compared to the volume thereof, is a natural material that is harmless to the human body, and is an eco-friendly material. Further, the expanded vermiculite has excellent non-flammability of the first grade and has also good absorption capacity as a porous structure, thereby being very effective when used as a chair mainly installed indoors.

The first mixture may include 50 to 70 wt. % of rosin powder pulverized into 300 to 325 mesh and 30 to 50 wt. % of alcohol based on a total weight thereof.

Some of the conventional furniture materials use liquid sodium silicate as a binder to reinforce strength. However, due to its characteristics, liquid sodium silicate has poor flowing property, and thus it is difficult to uniformly blend raw materials. Further, if a certain amount or more is excessively added, problems such as local agglomeration or lump formation may occur.

In order to solve the above problems, according to this embodiment, some of the liquid sodium silicate may be replaced with a first mixture consisting of rosin powder and alcohol, and used as a binder for expanded vermiculite, which will be described later.

Further, when the size of the pulverized rosin powder is less than 300 mesh, some of rosin powder particles may be exposed to the surface of the chair, hence making an ill appearance visually. If the size of the pulverized rosin powder exceeds 325 mesh, dispersibility may decrease, the homogeneity of the first mixture is lowered, and thus the second mixture is not properly liquefied, whereby a bonding force of the rosin powder may be lowered. As a result, the compressive strength of the chair may be reduced.

Such a rosin powder is a natural material with excellent adhesion and bonding force when liquefied, is harmless to the human body, and is present in interspaces of the expanded vermiculite to thus increase the bonding force between expanded vermiculite, thereby improving a compressive strength of the material formed by compression while heating at a high temperature. Further, since the rosin powder is a material having excellent waterproof properties, it may impart excellent waterproof properties to the finished chair.

If a content of the rosin powder in the first mixture is less than 50 wt. %, the bonding force between the expanded vermiculite is lowered, and thus the compressive strength of the chair may be reduced. However, since rosin is a vaporizable material, it is preferable that the content of rosin powder does not exceed 70 wt. % in order to maintain incombustibility of the product in the present invention at a certain level.

Further, if a content of alcohol in the first mixture is less than 30 wt. %, mixing may not be conducted properly when the first mixture is blended and some of the rosin powder may remain undissolved, hence reducing homogeneity. Further, if the alcohol content exceeds 50 wt. %, the content of the rosin powder is relatively small and thus the compressive strength may be reduced as described above.

The third mixture may be formed by admixing liquid sodium silicate and charcoal pulverized into 200 to 325 mesh.

At this time, if the size of the pulverized charcoal is less than 200 mesh, there may be a problem that the charcoal particles are exposed to the surface of the molded chair, hence making an ill appearance visually. If the size of the pulverized charcoal exceeds 325 mesh, it is not properly mixed with liquid sodium silicate and problems such as local agglomeration or clumping may occur. Therefore, the third mixture may not properly fill pores and interspaces of the expanded vermiculite. As a result, the quality and strength of the chair may be deteriorated.

The charcoal is a natural material that is harmless to the human body and is environmentally friendly, has excellent humidity control functions, excellent antimicrobial, sterilization and deodorization properties, and would be expected to have effects of emitting far-infrared rays.

Further, such charcoal may be made of a variety of wood as a raw material, preferably prepared from a raw material consisting of oak and pine.

In the present embodiment, the charcoal may include 20 to 50 wt. % of first charcoal powder based on an oak tree as a raw material and having a bar-shaped structure, and 50 to 80 wt. % of second charcoal powder based on a pine tree as a raw material and having a spherical structure.

At this time, the second charcoal powder may maintain a high viscosity of the second mixture in a thick state when blended with the second mixture, thereby serving to improve homogeneity. Further, the second charcoal powder may be filled in voids of the first charcoal powder that are in close contact with each other, in order to increase a density of the third mixture and, at the same time, may serve as a binder to assist the charcoal to be well combined with the liquid sodium silicate. Accordingly, as in the present embodiment, when a third mixture is prepared by forming charcoal that consists of the first charcoal powder and the second charcoal powder. As a result, the first charcoal powder and the second charcoal powder having different shapes may be combined in an entangled state to thus further improve a compressive strength and workability of a chair.

Further, as in the present embodiment, when the charcoal is composed of the first charcoal powder and the second charcoal powder, the content of charcoal in the third mixture may be limited to 15 to 25 wt. parts based on 100 wt. parts of liquid sodium silicate.

At this time, if the content of the first charcoal powder is less than 20 wt. %, the overall strength provided by the charcoal may decrease while the content of the second charcoal powder is relatively increased. Since pine wood is a material relatively vulnerable to heat, it is preferable to maintain the content of the first charcoal powder at 20 wt. % or more in order to maintain the non-flammability of the product in the present embodiment at a certain level.

Further, when the content of the first charcoal powder exceeds 50 wt. %, the homogeneity of the third mixture may decrease, hence causing a problem in that compression is not properly performed during chair molding.

Meanwhile, according to another embodiment, the third mixture may further include a third charcoal powder in addition to the first and second charcoal powders, if necessary.

In this case, the third mixture may be prepared by mixing 40 to 80 wt. parts of charcoal based on 100 wt. parts of liquid sodium silicate. If a content of charcoal is less than 40 wt. parts, a bonding force is lower and the strength of the composition may decrease, so that functional characteristics of charcoal such as excellent humidity control function, antimicrobial, sterilization and deodorization properties may not be properly realized.

Further, the third mixture may prepared by agitating 10 to 35 wt. % of the first charcoal powder, 25 to 45 wt. % of the second charcoal powder and 20 to 45 wt. % of the third charcoal powder based on 100 wt. parts of liquid sodium silicate for 2 to 3 hours.

Further, the third charcoal powder may be formed by burning rice husk at a high temperature under vacuum condition. The rice husk is an eco-friendly material that is inexpensive, has far-infrared radiation ability, and is harmless to the human body. Further, the third charcoal powder prepared from rice husk may have an advantage of being well mixed with liquid sodium silicate serving as an inorganic binder.

Accordingly, the third charcoal powder may act as a curing agent when reacted with liquid sodium silicate, whereby it may play a role of further improving incombustibility of furniture and increasing a strength thereof. If a content of the third charcoal powder is less than 20 wt. %, effects of the third charcoal powder may not be properly realized. On the other hand, if the content of the third charcoal powder is more than 45 wt. %, the bonding force may be lowered.

As such, with regard to the well-being heating chair 10 according to the present embodiment, the compact body may include 80 to 95 wt. % of the second mixture and 5 to 20 wt. % of the third mixture based on a total weight of the compact body.

The expanded vermiculite contained in the second mixture has a porous structure, while the resin powder of the first mixture may fill pores of the expanded vermiculite and some of interspaces in the expanded vermiculite. Agitating the second mixture and the third mixture may allow the third mixture to fill the remaining interspaces of the expanded vermiculite in the second mixture, whereby a compact body with greatly improved compressive strength can be formed.

At this time, if a content of the third mixture is less than 5 wt. %, some of the empty spaces in the second mixture are not filled so that the compressive strength of the chair to be molded may be reduced.

Further, if the content of the third mixture is more than 20 wt. %, a part of the third mixture may remain even after all the empty spaces of the second mixture are filled, hence causing a problem in that the compact body may have deteriorated homogeneity. Further, in this case, a content of the liquid sodium silicate may increase and make it difficult to uniformly blend the raw materials, hence causing problems such as local agglomeration or clumping of some components in the compact body. Consequently, there may be a problem of deterioration in quality of the compact body.

Hereinafter, preferred embodiments of a method for manufacturing the well-being heated chair 10 of the present invention will be described with reference to the accompanying drawings.

The manufacturing method of the well-being heating chair 10 according to the present invention may include steps of: (a) preparing a compact body; (b) mounting a heat transfer unit 20 in a plate compact member 10″; and (c) mounting a charcoal block 30 in the plate compact member 10″ such that the charcoal block 30 is disposed on one side of the heat transfer unit 20.

In the step (b), the heat transfer unit 20 may be built in the prepared compact body, more specifically, an insertion groove of the plate compact member 10″. The plate compact member 10″ may be provided with a wire path for wiring when the heat transfer unit 20 is built therein if necessary.

After the heat transfer unit 20 is built therein, the charcoal block 30 may be disposed to cover the heat transfer unit 20. If necessary, a cover may be overlaid on the plate compact member 10″ in which the charcoal block 30 is disposed.

The step (a) of preparing the compact body may be subdivided into the following steps, and will be described in detail with reference to the accompanying drawings.

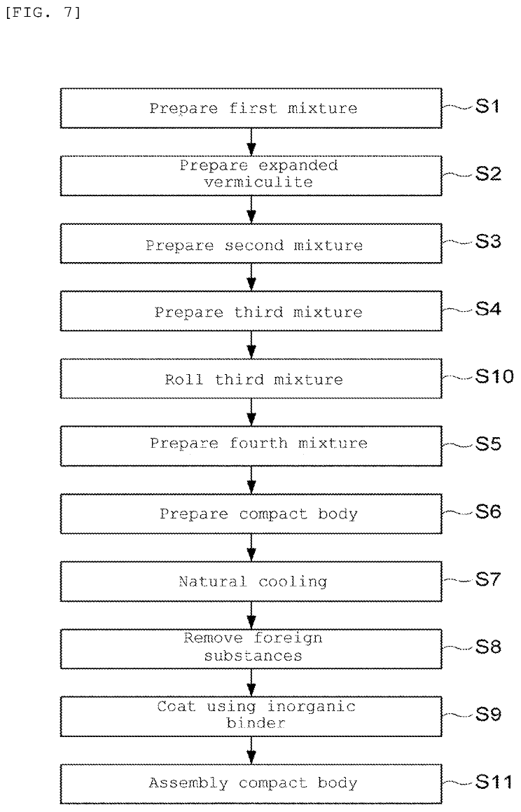

As shown in FIG. 6, a first step of firstly pulverizing the rosin powder into 300 to 325 mesh, and admixing 50 to 70 wt. % of the pulverized rosin powder and 30 to 50 wt. % of alcohol is performed (S1). At this time, since the alcohol may be vaporized when the mixing temperature of the rosin powder and the alcohol is high, the first step is preferably performed at room temperature.

In this case, if some of the existing liquid sodium silicate is replaced with rosin powder, the problem of lowering flowability of the liquid sodium silicate is minimized. Therefore, when admixing raw materials, it may be smoothly performed, and deliquescence is eliminated thereby greatly reducing occurrence of whitening.

Accordingly, when the formed body is molded with the fourth mixture to be described later, quantitative introduction may be smoothly performed, and therefore, a molding time of the formed body may be relatively shortened. As a result, effects of improving production costs and production efficiency of the chair can be expected.

Next, a second step of preparing and crushing expanded vermiculite may be performed (S2). In order to proceed with the second step, first, vermiculite is rapidly heated at 1,000 to 1,100° C. so that it expands up to about 20 times. Accordingly, the expanded vermiculite as a main component may be prepared by transforming the vermiculite into a porous material having numerous pores.

In this case, when the vermiculite is calcined at a temperature lower than 1,000° C., some of the vermiculite may be less calcined and properties of the expanded vermiculite prepared may be deteriorated. On the other hand, when the vermiculite is calcined at a temperature higher than 1,100° C., the vermiculite particles may become dry or crumbly, and the vermiculite powder may be blown out or part of the vermiculite may be aggregated into a lump when mixing the raw materials.

Then, the expanded vermiculite after the second step is pulverized into particles having a size of 20 to 25 mesh. If the size of the pulverized expanded vermiculite exceeds 25 mesh, it is difficult to blend the raw materials, which may cause a problem in that liquefaction of the second mixture is not properly proceeded in a third step described later.

If the second mixture is not properly liquefied, workability may be significantly lowered when the compact body for manufacturing the chair is prepared so that, even if the compact body is processed by pressing the fourth mixture of the present embodiment at a high temperature and high pressure, there may be problems that a product is not properly formed with a shape desired by the manufacture or its quality may be significantly deteriorated.

On the other hand, since the second step of expanding vermiculite is a process of heating the vermiculite at a very high temperature for a certain period of time, purification in which all foreign substances such as radon and various bacteria in the vermiculite are removed can be performed together. Therefore, the stability of the chair may further be improved.

Next, a third step of preparing a liquefied second mixture using the expanded vermiculite pulverized in the second step as a main component proceeds (S3). In this third step, 5 to 30 wt. parts of the first mixture is mixed with respect to 100 wt. parts of expanded vermiculite and stirred at 100° C. for 1 to 2 hours in order to prepare the second mixture.

At this time, the second mixture may be formed by simultaneously adding the first mixture and expanded vermiculite to a mixer, and then stirring the mixture at 100° C. for 1 to 2 hours and cooling naturally.

In this case, the stirring and natural cooling process of the expanded vermiculite and the first mixture is preferably repeated 5 times. This is performed to increase a viscosity of the second mixture to a level at which fluidity thereof may be appropriately maintained while improving reactivity of the second mixture with a third mixture described later, thereby enhancing the workability when fabricating a chair with a fourth mixture described later.

If the process of stirring and natural cooling the expanded vermiculite and the first mixture is repeated 4 times or less, the viscosity of the second mixture is not increased to ensure a sufficient level of fluidity and, as a result, problems such as reduced reactivity with the third mixture and decrease in strength of the chair may occur.

Further, the stirring and natural cooling process of the expanded vermiculite and the first mixture is preferably repeated only 5 times, since there is no significant difference in effects even if repeated 6 or more times.

Then, a fourth step is proceeded such that the charcoal is pulverized into 200 to 325 mesh, and liquid silicate soda (sodium silicate) serving as an inorganic binder and the pulverized charcoal are stirred to prepare a third liquefied mixture (S4). Since the third mixture fills the pores and interspaces of the expanded vermiculite in the second mixture, it may increase the strength of the molded chair.

Further, according to the present embodiment, such charcoal may be made of a variety of wood as a raw material, preferably from a raw material consisting of oak and pine.

According to the present embodiment, the charcoal may include two types of charcoal powder having different textures, and more specifically, first charcoal powder having a large and elongated bar-shaped structure and second charcoal powder having a relatively small and rounded sphere-shaped structure.

The first charcoal powder may be prepared by burning oak wood at 800° C. under vacuum condition and may have a relatively higher strength, while the second charcoal powder may be prepared by burning pine wood at 800° C. under vacuum condition.

According to the present embodiment, the charcoal preferably includes 20 to 50 wt. % of the first charcoal powder and 50 to 80 wt. % of the second charcoal powder.

Meanwhile, according to another embodiment, the third mixture may be prepared by further mixing and stirring the third charcoal powder. At this time, the third mixture may be prepared by mixing 40 to 80 wt. parts of charcoal based on 100 wt. parts of liquid sodium silicate. If a content of charcoal is less than 40 wt. parts, a bonding force is lowered to reduce the strength of the composition, and the functional characteristics of charcoal such as excellent humidity control function, antimicrobial, sterilization property and deodorization properties may not be properly realized.

The third charcoal powder may be prepared by burning rice husk at 1,500° C. under vacuum condition. The reason why rice husk is preferably used in preparing the third charcoal powder in the present embodiment is because the rice husk has very high carbon content.

Further, the first to third charcoal powders obtained through the above process are preferably mixed with liquid sodium silicate after passing through five crushing operations. At this time, if the crushing operation is repeated less than 5 times, homogeneity of the third mixture may be reduced and a bonding force of the liquid sodium silicate may decrease.

Further, as shown in FIG. 7, if necessary, the third mixture prepared as described above may be subjected to operations of rolling the mixture to a thickness of 2 to 3 mm using a roller in a rolling mill while pressing as a following process (S10) may be additionally repeated 3 times.

According to the above operations, the first to third charcoal powders included in the third mixture may be spread evenly throughout the third mixture, thereby improving adhesion. As a result, the strength of the composition may be improved.

Next, a fifth step of preparing the fourth mixture by admixing the second mixture and the third mixture is performed (S5). In this case, the fourth mixture may be prepared by stirring 80 to 95 wt. % of the second mixture and 5 to 20 wt. % of the third mixture for 2 to 3 hours based on a total weight of the fourth mixture.

The expanded vermiculite contained in the second mixture has a porous structure, and the resin powder of the first mixture fills the pores and some of the interspaces of the expanded vermiculite. When the second mixture and the third mixture are stirred, the third mixture fills empty voids or interspaces of the expanded vermiculite in the second mixture, thereby forming a fourth mixture having significantly improved compressive strength.

In this case, if a content of the third mixture is less than 5 wt. % a part of the space in the second mixture may not be filled so that the compressive strength of the compact body and the completed chair may be reduced.

Further, if the content of the third mixture is more than 20 wt. %, a portion of the third mixture remains even after all the empty spaces of the second mixture are filled, resulting in a problem that homogeneity of the fourth mixture decreases. Further, in this case, the content of the liquid sodium silicate increases, hence making it difficult to uniformly blend the raw materials, whereby problems such as agglomeration or clumping of some components in the fourth mixture may occur.

Next, a sixth step including: fabricating a mold having a shape corresponding to the shape of the chair to be produced; introducing the fourth mixture into the mold heated at 180 to 230° C.; and pressing the same by means of a high pressure hydraulic press of 2,000 to 2,300 tons to provide a compact body with desired shapes is proceeded (S6). At this time, the mold may have different shapes and thicknesses depending on the chair.

For example, the compact body may be configured of a rod-shaped support compact member 10′ and a plate-shaped plate compact member 10″, each of which is pressed and fabricated, wherein both of the members are assembled together to construct the shape of a chair. The plate compact member 10″ may be used as a seat or a backrest of the chair 10, and the support compact member 10′ may serve as a leg of the chair 10.

The support compact member 10′ and the plate compact member 10″ are assembled together to complete the shape of a chair in a tenth step (S11) described later.

On the other hand, according to the present embodiment, instead of mixing all the components at once to prepare the fourth mixture as a final product, rosin powder and alcohol are firstly blended to prepare a first mixture containing homogenous rosin powder, the fist mixture is mixed with expanded vermiculite to prepare a second mixture containing homogeneous and liquefied expanded vermiculite, a third mixture in which charcoal becomes homogeneous is prepared by admixing liquid sodium silicate and finely pulverized charcoal, and then, the second mixture and the third mixture are blended to fill interspaces of the expanded vermiculite with the charcoal, thereby preparing a fourth mixture which is homogeneous and has an excellent bonding force between the components so as to obtain a high strength. Accordingly, all the beneficial effects of individual components are obtained while minimizing possible problems occurring when the components are admixed.

As such, when the compact body is pressed at high temperature and high pressure for 5 minutes, heat is evenly transferred throughout the fourth mixture inside the mold, therefore, particles of various components contained in the fourth mixture may also be evenly bonded together due to heat and high pressure, thereby achieving a chair having excellent strength and various functional features such as incombustibility which are uniformly provided.

In particular, voids formed in the expanded vermiculite are filled with charcoal and interspaces of the same are filled with sodium silicate and rosin powder while being combined together, whereby a well-being heating chair which is lightweight and has superior strength and non-flammability than existing chairs can be manufactured.

At this time, if a pressing time with heat is less than 5 minutes, heat cannot be transmitted evenly inside the mold and the particles of various components contained in the fourth mixture do not react properly, so that a shape of the chair may not be completely or properly formed or defective products with partially deteriorated characteristics of the chair may be produced.

Following this, a seventh step of demolding the compact body from the mold and then natural cooling the same for 72 hours or more is performed (S7). If a natural cooling time in the seventh step is less than 72 hours, the strength of the compact body may be reduced. Further, when the temperature at which the compact body is cooled is significantly different from room temperature, defects such as cracks may occur in a drying process of the compact body.

Further, an eighth step of removing foreign substances on the surface of the compact body using sandpaper or chamfering is performed (S8). In the present invention, such a removal process of foreign substances is not particularly limited to sandpaper or chamfering as described above, and may be performed through various other methods.

Further, a ninth step of coating the surface of the compact body with an inorganic binder is performed (S9). To this end, an inorganic binder is first applied to a top surface and lateral sides of the compact body, followed by drying; then, the compact body is turned over, followed by secondly coating a bottom surface and lateral sides of the compact body with an inorganic binder then drying the same.

Thereafter, a tenth step of assembling the support compact member 10′ and the plate compact member 10″ to construct a chair like structure is performed (S11).

The chair 10 may be configured by combining only the support compact member 10′ and the plate compact member 10″. Alternatively, a joint member 10′″ to connect the plate compact members 10″ may be additionally included.

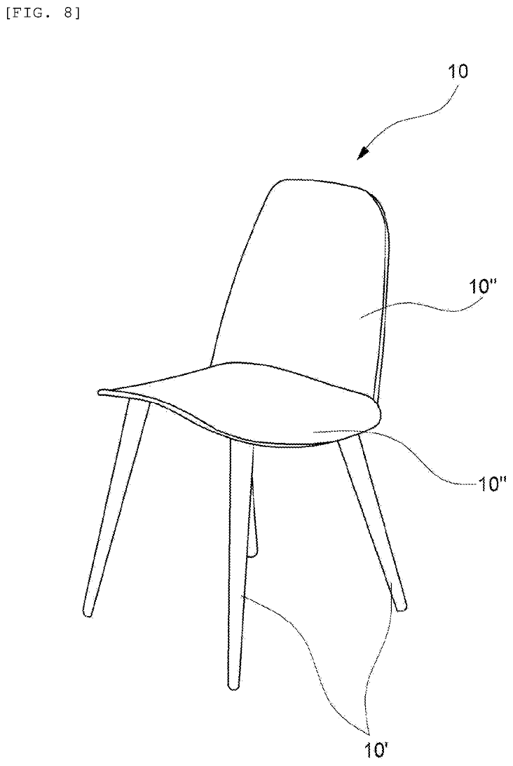

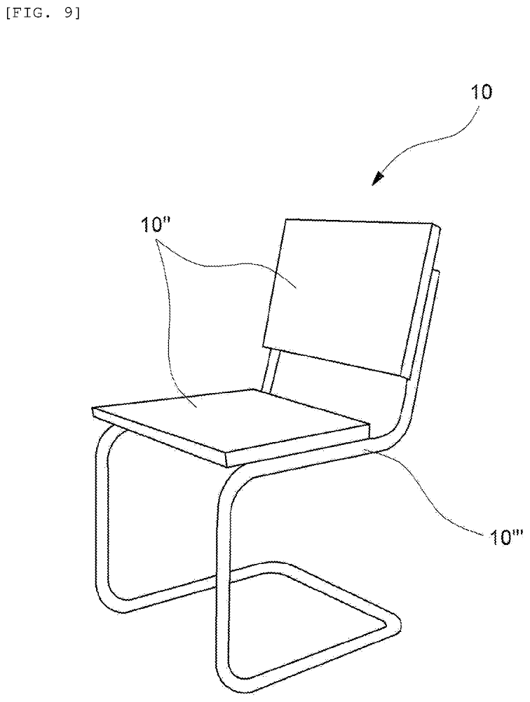

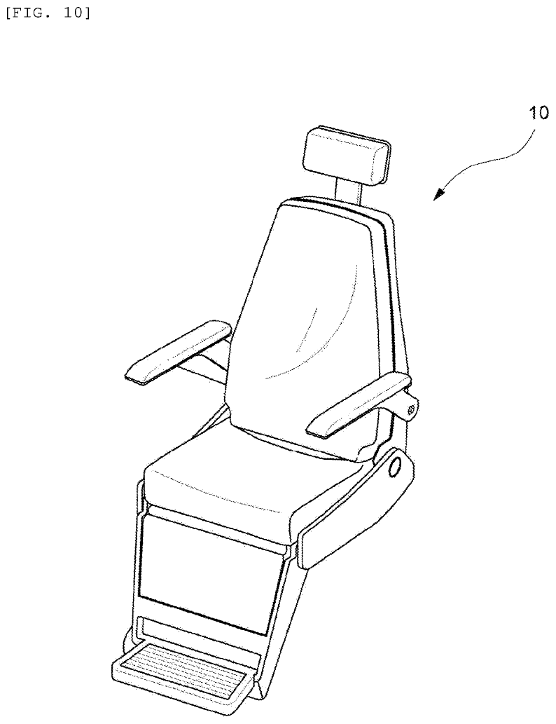

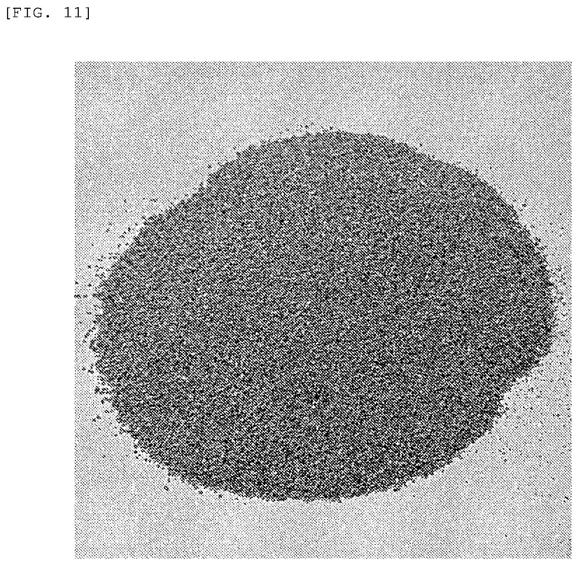

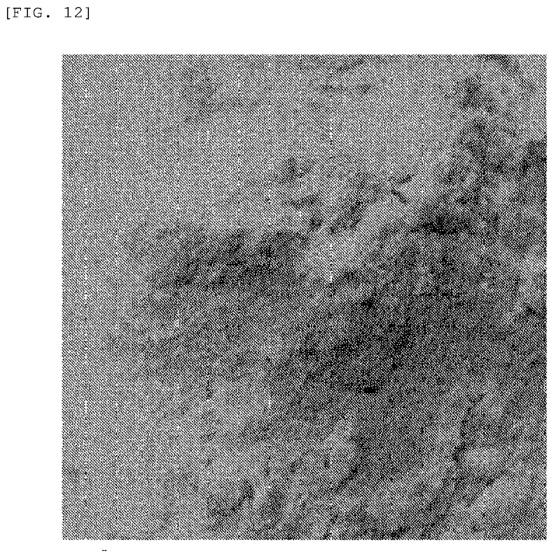

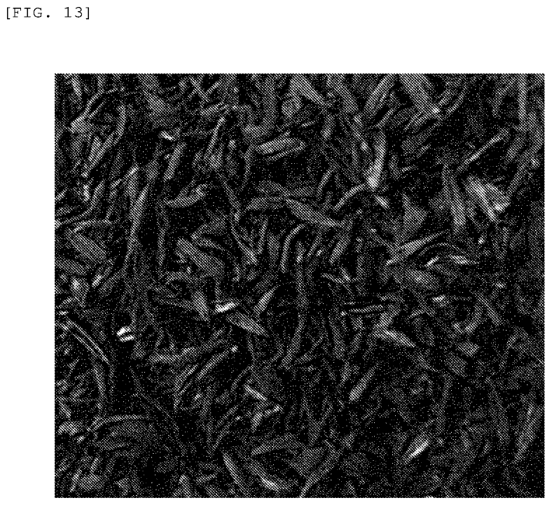

In addition, as shown in FIGS. 8 to 10, various types of compact bodies for designing an ergonomic chair may, of course, further be included.

Meanwhile, the chair of the present invention may be modified in different forms other than those described above, and all modified embodiments should also be construed as belonging to the scope of the present invention, unless departing from the technical spirit of the present invention.

### DESCRIPTION OF REFERENCE NUMERALS

S1: Prepare first mixture

S2: Prepare and crush expanded vermiculite

S3: Prepare second mixture

S4: Prepare third mixture

S5: Prepare fourth mixture

S6: Prepare compact body

S7: Cool compact body

S8: Remove foreign substances from the compact body

S9: Coat the surface of the compact body

S10: Roll and press the third mixture

10: chair

20: Heat transfer unit

30: Charcoal block

1. A well-being heating chair, comprising:
a compact body including a plate-shaped plate compact member and a rod-shaped support compact member;
a heat transfer unit built in the plate compact member; and
a charcoal block built in the plate compact member and disposed on one side of the heat transfer unit,
wherein the plate compact member is used as a seat and a backrest of the chair, and the support compact member is used as a leg of the chair.

2. The well-being chair according to claim 1, wherein the compact body is composed of:
a second mixture prepared by admixing expanded vermiculite pulverized into 20 to 25 mesh after heating the same at 1,000 to 1,100° C. and 5 to 30 parts by weight (“wt. parts”) of a first mixture with respect to 100 wt. parts of the expanded vermiculite; and
a third mixture prepared by admixing liquid sodium silicate and charcoal pulverized into 300 to 325 mesh,
wherein: the first mixture includes 50 to 70% by weight (“wt. %”) of rosin powder pulverized into 300 to 325 mesh and 30 to 50 wt. % of alcohol to a total weight;
the second mixture is formed by simultaneously introducing the first mixture and the expanded vermiculite into a mixer and mixing the same, followed by agitating the mixture at 100° C. for 1 to 2 hours then naturally cooling the same, and repeating this process 5 times;
the third mixture is formed by repeating a pressing process in a rolling mill 3 times;
a fourth mixture is prepared by agitating 80 to 95 wt. % of the second mixture and 5 to 20 wt. % of the third mixture for 2 to 3 hours;
the fourth mixture is pressed by means of a hydraulic press having a pressure of 2,000 to 2,300 tons at 180 to 230° C. for 5 minutes to form a compact body; and
the first mixture is formed by admixing the rosin powder and alcohol at room temperature.

3. The well-being heating chair according to claim 2, wherein the third mixture includes 40 to 80 wt. parts of charcoal based on 100 wt. parts of liquid sodium silicate, wherein the charcoal includes 10 to 25 wt. % of first charcoal powder based on an oak tree as a raw material and having a rod-shaped structure, 25 to 45 wt. % of second charcoal powder based on a pine tree as a raw material and having a spherical structure, and 20 to 45 wt. % of third charcoal powder formed by burning rice husk at a high temperature under vacuum condition.

4. A method for manufacturing a well-being chair, comprising:
(a) preparing a compact body;
(b) mounting a heat transfer unit in a plate compact member; and
(c) mounting a charcoal block in the plate compact member such that the charcoal block is disposed on one side of the heat transfer unit,
wherein the step (a) includes:
a first process of preparing a first mixture by admixing 50 to 70 wt. % of rosin powder pulverized into 300 to 325 mesh and 30 to 50 wt. % of alcohol at room temperature;
a second process of heating vermiculite at 1,000 to 1,100° C. to prepare expanded vermiculite, followed by pulverizing the same into 20 to 25 meshes;
a third process of preparing a second mixture in a liquid state by mixing 5 to 30 wt. parts of the first mixture with respect to 100 wt. parts of the expanded vermiculite, followed by agitating the same at 100° C.;
a fourth process of preparing a third mixture in a liquid state by admixing liquid sodium silicate and 40 to 80 wt. parts of charcoal pulverized into 300 to 325 mesh with respect to 100 wt. parts of the liquid sodium silicate, followed by agitating the same for 2 to 3 hours;
a fifth process of preparing a fourth mixture by agitating 80 to 95 wt. % of the second mixture and 5 to 20 wt. % of the third mixture for 2 to 3 hours with respect to a total weight of the fourth mixture;
a sixth process of pressing the fourth mixture by means of a hydraulic press having a pressure of 2,000 to 2,300 tons at 180 to 230° C. for 5 minutes to form a compact body composed of a rod-shaped support compact member and a plate-shaped plate compact member;
a seventh process of demolding and naturally cooling the compact body for 72 hours or more;
an eighth process of removing foreign substances including impurities on the surface of the compact body;
a ninth process of firstly coating a top surface and lateral sides of the compact body with an inorganic binder then drying the same, followed by turning the compact body over, secondly coating a bottom surface and lateral sides of the compact body with an inorganic binder then drying the same; and
a tenth process of assembling the support compact member and the plate compact member to construct a chair-shaped structure.
